(19) United States
(12) Patent Application Publication
(10) Pub. No.: US 2008/0162644 A1
(43) Pub. Date: Jul. 3, 2008

(54) AUTO SELECTION OF CONNECTORS IN A MIDDLEWARE FRAMEWORK

(76) Inventors: KALYANARAMAN B. KRISHNAN, Vellore (IN); Ravi Prasad, Bangalore (IN)

Correspondence Address: SAP AG, 3410 HILLVIEW AVENUE, PALO ALTO, CA, 94304, US

(21) Appl. No.: 11/617,791

(22) Filed: Dec. 29, 2006

(51) Int. Cl. G06F 15/16

(52) U.S. Cl. 709/206

(57) ABSTRACT

The invention describes a method for auto selection of connectors in a middleware. The method includes receiving a message at a middleware, dynamically identifying if a connector for a target system is capable of handling the message and transmitting the message to a capable connector.

### FIELD OF THE INVENTION

The invention relates to a middleware framework. More particularly, the invention relates to a method and system for auto selection of connectors in the middleware framework.

### DESCRIPTION OF THE RELATED ART

It is often necessary for systems running on different types of hardware and operating under different types of software to communicate with each other. One such situation is where a client system needs to access a target system to request processing or access to data.

Traditionally, middleware has facilitated these interactions. The middleware provides client systems, application programs or their components, with an access to different types of systems, such as transaction servers or database systems, referred to as target systems. The middleware is often provided as a library which provides to the client system a well defined set of application programming interfaces (APIs) to access the middleware and the target systems through connectors associated with such target systems. Typically, a client system provides a message and a message metadata to the middleware. Based upon target system information contained in the message metadata, the middleware selects a connector that is associated with the target system to which the message is to be transmitted. In particular, the middleware acts as a conduit for the data, carrying information and requests from the client to the server and back.

Each connector is specific to at least one target system and is connected to a target system on one end and to a middleware on other end. These connectors provide the client system with a variety of programming models, interfaces and protocols to communicate and access the target systems. The connector translates the client request and data between a format prescribed by the client system and a format prescribed by the connector. Such translation enables integration and interoperability of client systems and target systems working on different types of hardware and operating under different types of software.

One problem with the use of middleware in this way is that based upon the message metadata, there is a need to identify which connector is to be selected for transmitting a particular message. Since the message metadata is often set by the client system, the client system has to have an awareness of the target system to which the message is to be transmitted.

Furthermore, the connector tends to be specific to a target system. Thus, a client application or components written to deal with one type of connector connecting to a particular target system type may have to be modified or rewritten in order to connect with a different target system type. A developer would need to know the details of each connector with which the client system will interact in order to write code for the client application or components. This may increase the difficulty of developing new target system applications.

A related problem is lack of target system information in the message metadata which arises, when a new target system connects to the middleware during runtime. In this scenario, the message metadata will not contain any information regarding the new target system in the message metadata because of unavailability of new target system information in the client system. In such a situation, the message will not be transmitted to such new target system.

In another related problem, if a client system is to communicate with several target systems, the client system will be required to communicate using several specific APIs. The result is that the client system has to support an ever growing number of specific application programming interfaces (APIs) and to develop client application to take care of ever growing number of connectors associated with several target systems. The more versatile and powerful the target systems become, the more complex the access of the target systems by the client system through connectors becomes.

### SUMMARY OF THE INVENTION

The invention describes a method for auto selection of connectors in a middleware framework. The method includes receiving a message at a middleware, dynamically identifying if a connector for a target system is capable of handling the message and transmitting the message to a capable connector.

### BRIEF DESCRIPTION OF THE DRAWINGS

The embodiments of the invention, together with its advantages, may be best understood from the following detailed description taken in conjunction with the accompanying figures in which:

FIG. 1 illustrates a method for auto selection of a connector in a middleware according to an embodiment of the invention.

FIG. 2 illustrates connectivity of a client system with a plurality of target systems according to an embodiment of the invention.

FIG. 3 illustrates connectivity of a client system with a plurality of target systems according to another embodiment of the invention.

FIG. 4 illustrates a method for dynamic identification of connectors in a middleware according to an embodiment of the invention.

FIG. 5 illustrates a method for dynamic identification of connectors in a middleware according to another embodiment of the invention.

FIG. 6 illustrates an architectural diagram for auto selection of connectors in a middleware according to an embodiment of the invention.

FIG. 7 illustrates an architectural diagram for auto selection of connectors in a middleware according to another embodiment of the invention.

FIG. 8 illustrates architecture of a middleware according to an embodiment of the invention.

FIG. 9 illustrates architecture of an identifier according to an embodiment of the invention.

FIG. 10 illustrates architecture of a connector according to an embodiment of the invention.

### DETAILED DESCRIPTION

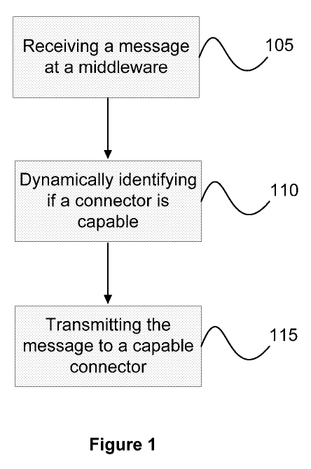

Embodiments of the invention are generally directed to a method and a system for auto selection of connectors in a middleware. An embodiment of the invention describing the method is shown in FIG. 1. The method includes receiving a message at a receiver in a middleware 105. At 110, a determination is made to dynamically identify if a connector for a target system is capable of handling the message. The dynamic identification of the connector is described in greater detail below. At 115, the message is transmitted to a capable connector, that is, to a connector which is capable of handling the message.

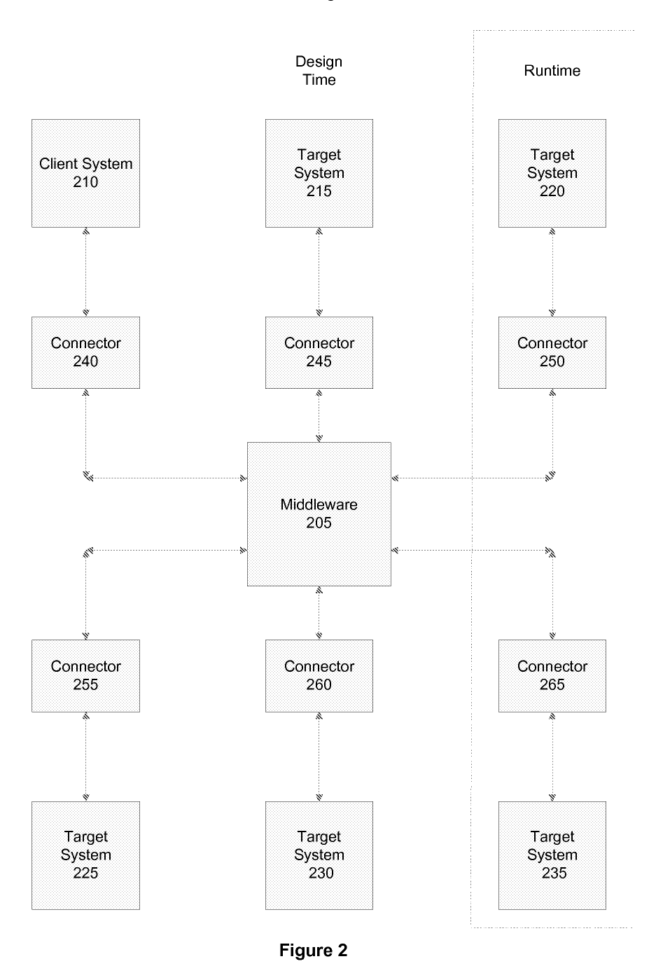

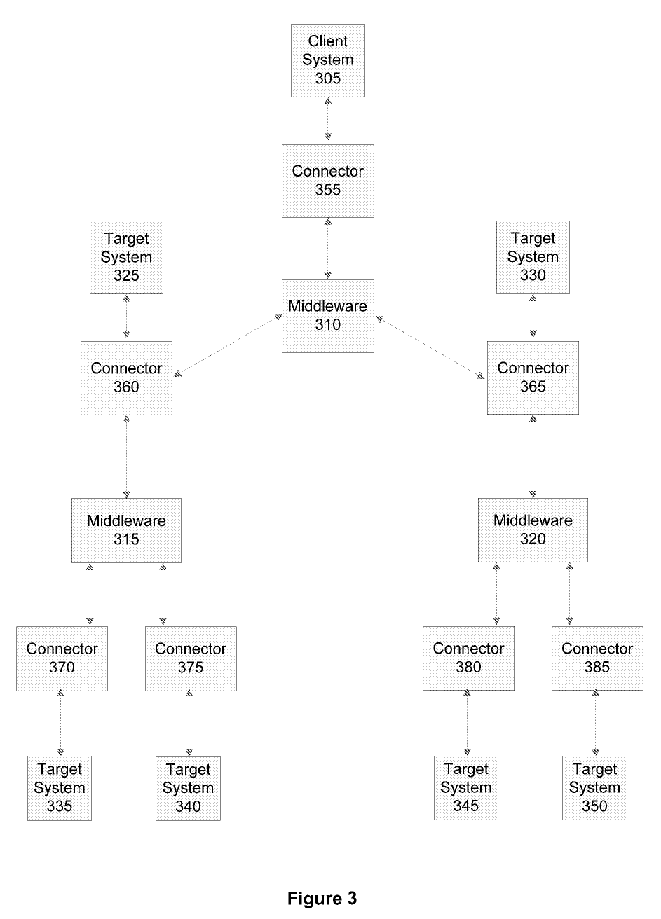

FIG. 2 and FIG. 3 show embodiments of environment where the invention may work.

FIG. 2 illustrates connectivity of a client system with a plurality of target systems according to an embodiment of the invention. The client system 210 is connected through a connector 240 through a connector 240 to a middleware 205. The middleware is connected to a plurality of target systems 215, 220, 225, 230 and 235 through connectors 245, 250, 255, 260 and 265. The plurality of target systems includes both design time target systems 215, 225 and 230 as well as runtime target systems 220 and 235. The design time target systems 215, 225 and 230 include target systems which are connected with the middleware before a message is sent from the client system 210 to the middleware 205. However, the runtime target systems 220 and 235 include target systems which connect to the middleware after the message is sent from the client system 210 to the middleware 205.

FIG. 3 illustrates connectivity of a client system with a plurality of target systems according to another embodiment of the invention. The client system 305 is connected through a connector 355 to a middleware 310. The middleware 310 connects the client system 305 to target systems 325 and 330 through connectors 360 and 365. The client system is also connected to a target system 335 through a connector 370, a middleware 315, the connector 360, the middleware 310 and the connector 355. Similarly, target systems 340, 345 and 350 are connected to the client system 305 through respective connector 375, 380 and 385, respective middleware 315 and 320, respective connector 360 and 365, the middleware 310 and the connector 335. The plurality of target systems may include both design time target systems and runtime target systems in any configuration or connectivity pattern.

In above environments, a message is received at a middleware (refer FIG. 2, 205 and refer FIG. 3, 310). A determination is made to dynamically identify which connector for a plurality of target systems is capable of handling the message. The determination is also made for connectors (refer FIG. 3, 370, 375, 380 and 385), which are not directly connected to the middleware (refer FIG. 3, 310). If the message is delivered to the middleware (refer FIG. 3, 315 and 320), the middleware dynamically identifies capable connectors which are connected to such middleware (refer FIG. 3, 315 and 320). Then, the message is transmitted to at least one connector capable of handling the message.

The client system may include application programs or their components and the target system may include transaction servers or database systems. However, this disclosure is not limited to any particular environment or computing device. Those of skill in the art will recognize that many other embodiments with respect to use of heterogeneous computing devices with different processing power, usability and portability are possible. Similarly, connectivity of a plurality of target systems and client system in different configuration or connectivity pattern is possible and fully within the scope and spirit of this disclosure for example the client system may directly connect to the middleware without any associated connector. Similarly, in a different configuration, the client system may also act as a target system.

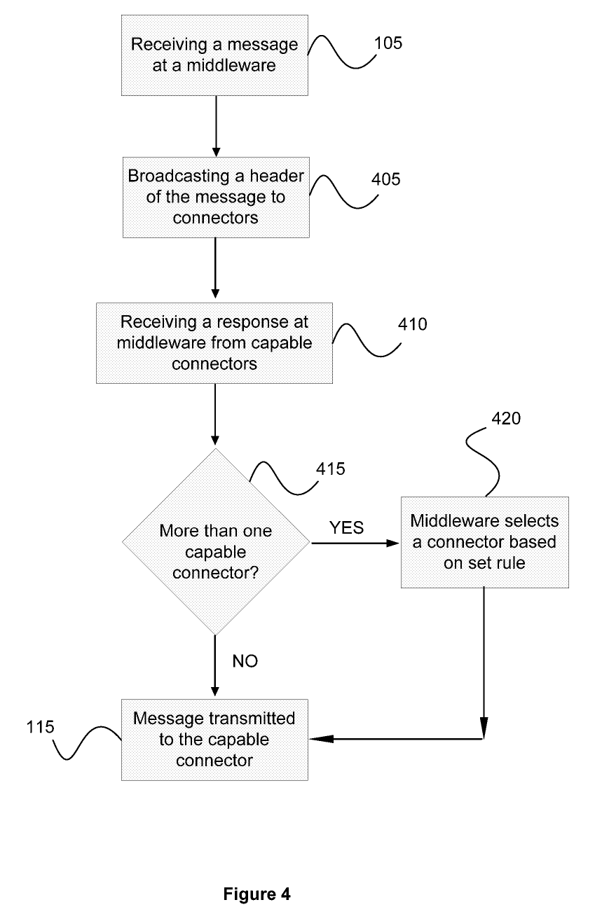

FIG. 4 illustrates an embodiment for dynamic identification of the connectors capable of handling a message. At 105, a message is received at a receiver in the middleware. The dynamic identification is illustrated at 405 and 410. At 405, a header of the message is broadcasted to at least one connector. At 410, a response is received at a receiver in the middleware from connectors which are capable of handling the message. For example, a middleware receives a message having a payload and a header, wherein the header defines conditions such as a message with object type X following communication protocol A. The middleware, then, broadcasts the header to the connectors, which are associated with both design time target systems and run time target systems. The connectors which are capable of understanding the conditions and of processing message with object type X following the communication protocol A are classified as capable connectors. All connectors providing such capability send a response to the middleware. The response may include notification from the connector, for example as an extensible markup language (XML) notification, indicating that the connector may process the message. The processing includes translating the message from a middleware understandable structure (in this case communication protocol A) to a target system understandable structure (a communication protocol B) and vice versa. The response will also include, but not limited to, internet protocol (IP) network address of the connector, target system identifier and location such as folder path within the target system to which the message will be transmitted. At 415, a determination is made if there is more than one connector capable of handling the message. At 420, the middleware selects a connector from the responding connectors based on set rules. The set rules may include, but not limited to, response time based on routing, resource utilization, interface coupling, technical coupling and security features. At 115, based upon the IP network address of the capable connector, the message is transmitted to the selected connector. The message is then transmitted to the target system associated with the selected connector.

The message includes a header and a payload. The header may include metadata of at least one of object types, user identifiers, object instances, scenarios, message identifiers, version or extensible custom properties. The object type defines the type of object in the payload. The user identifiers identify the users on whose data store an operation, such as to persist an object, is to be performed. The scenario defines the business scenario for which the operation is performed. The message identifier is a unique identifier for the message. The version includes information regarding version of the message. The extensible custom properties include additional information about the payload, for example message type, origin of message, routing information, content type, content name and content lifetime information. The payload contains content and/or request which is to be transmitted to the target system.

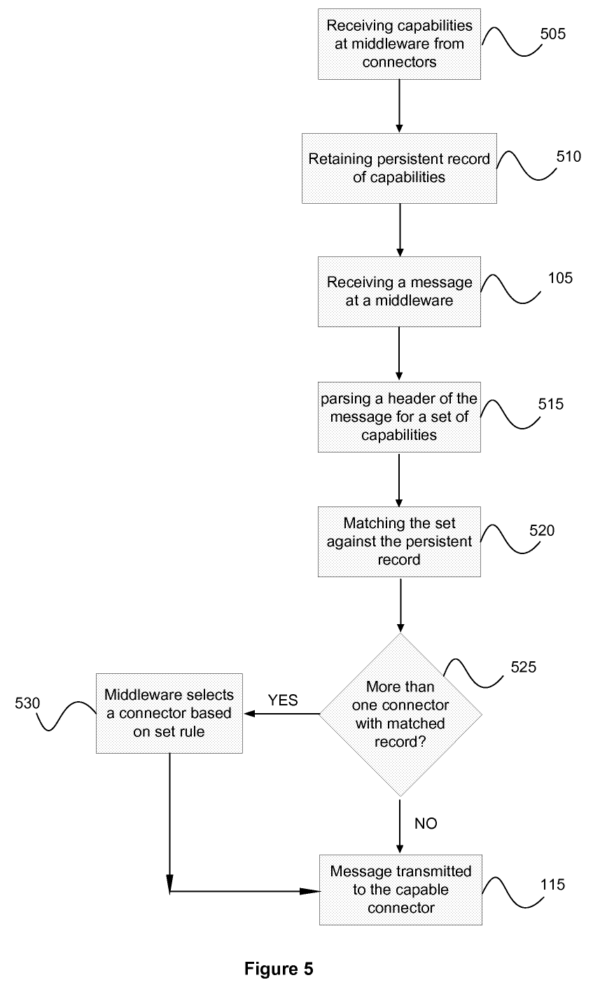

FIG. 5 illustrates another embodiment for dynamic identification of connectors capable of handling a message. 505 and 510 describe when a connector connects to a middleware. At 505, capabilities of the connector connecting to the middleware are received at a receiver in the middleware. The capabilities may be sent from the connector to the middleware in formats such as in an extensible markup language (XML) information. The capabilities may include values for attributes such as system connectivity capability, an object types supported, users supported, operations supported, version supported, transmission protocols supported or extensible properties. Extensible properties may include information like ethernet identifiers, internet protocol (IP) network address of the connector, target system and location such as folder path within the target system to which the message will be transmitted. At 510, a persistent record of capabilities is retained in a registry in the middleware. The persistent record may be retained in a structured form with a connector identifier associated with each persistent record.

At 105, a message is received at a receiver in the middleware. The dynamic identification is illustrated at 515 and 520. At 515, a header of the message is parsed for a set of capabilities required to handle the message. At 520, the set of capabilities is matched with the persistent record. For example, when the middleware receives a message, the header of the message is parsed for a set of capabilities required to handle the message, such as object type X following communication protocol A. The set of capabilities of the connectors connected to the middleware is matched with the persistent record representing capabilities of the connectors. The matching includes matching the set of capabilities with capabilities entry of the connector to find connectors with a matched record. In this scenario, based on the capabilities entry in the registry for each connector in persistent object type identifier and persistent communication protocol identifier, matching is done to find a persistent record with entry of object type X following communication protocol A. If a connector is identified with the matched record, the connector is classified as a capable connector.

At 525, a determination is made if there is more than one connector with the matched record. If there is more than one connector with matched record, then at 530, based on set rules the middleware selects a connector from the capable connectors with matched record. The set rules are already described above in this disclosure. At 115, the message is transmitted to the selected connector.

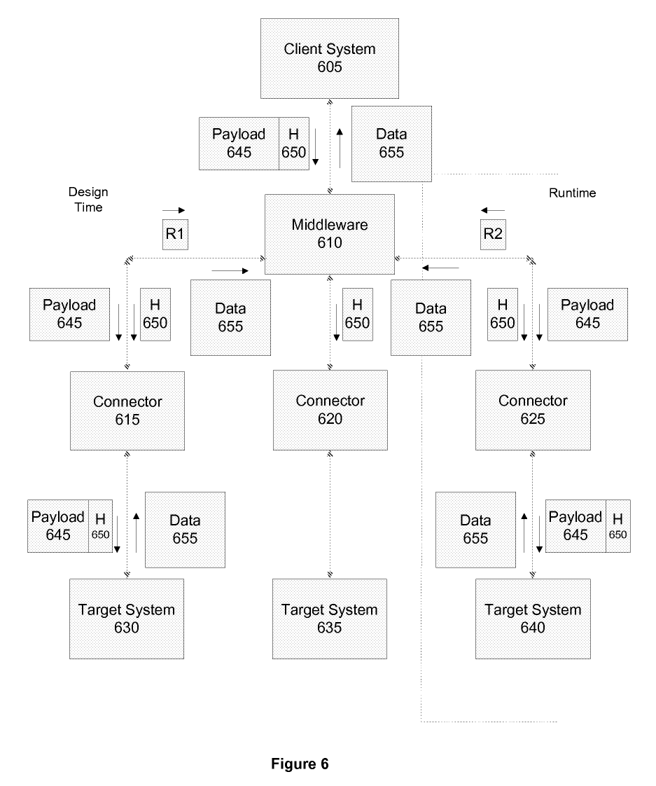

FIG. 6 illustrates an architectural diagram for auto selection of connectors in a middleware according to an embodiment of the invention. A client system 605 provides a message, which is received at a receiver in a middleware 610. The message includes a payload 645 and a header 650. The middleware parses the header 650 and broadcasts the header 650 to available connector(s). In present scenario, the middleware broadcasts the header 650 to connectors 615, 620 and 625. Connectors 615 and 620 are associated with design time target systems 630 and 635. Whereas, connector 625 is associated with a run time target system 640. Based upon metadata of the header 650, the connectors that are capable of handling the message send a response, which is received at the middleware 610. In present scenario, the middleware receives response R1 and R2 from capable connectors 615 and 625. If more than one connector is capable of handling the message (in present scenario, connectors 615 and 625), the middleware selects the connector to which the payload 645 is to be transmitted. If the middleware 610 transmits the payload 645 to the connector 615, the connector 615 transmits the message to corresponding target system 630 and provides access to the target system 630 to request processing or access to data 655.

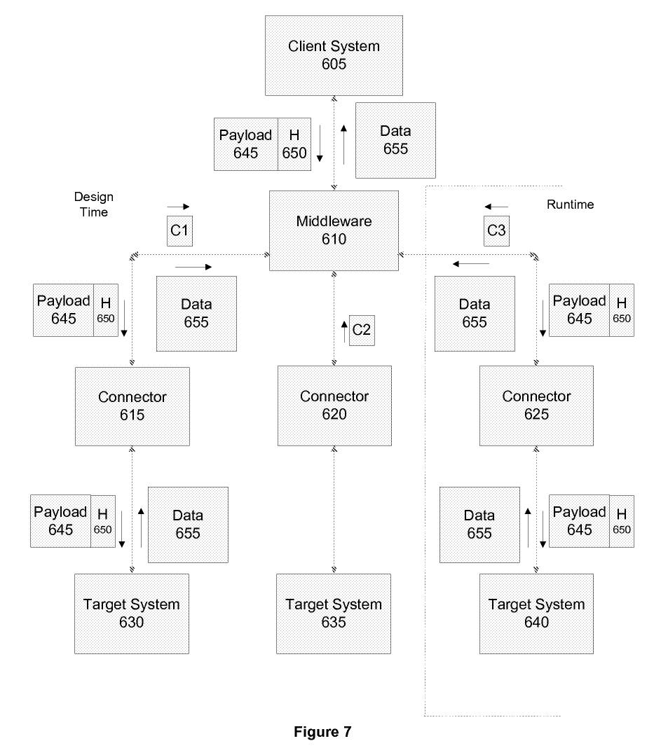

FIG. 7 illustrates another architectural diagram for auto selection of connectors in a middleware according to another embodiment of the invention. When a connector connects to a middleware 610, capabilities of the connector are received at a receiver in the middleware 610. In present scenario, capabilities C1, C2 and C3 of connectors 615, 620 and 625 are received at the middleware and retained as a persistent record in a registry. In present scenario, the connectors 615, 620 and 625 connecting to the middleware 610 includes connectors 615, 620 and 625 of both design time target systems 630 and 635 and a run time target systems 640. The capabilities are retained in the middleware as a persistent record. A client system 605 provides a message, which includes a payload 645 and a header 650. The message is received at the middleware 610, which parses the header 650 of the message for a set of capabilities required to handle the message. The set is matched against the persistent record. If there is more than one connector with matched record, based upon set rules the middleware 610 selects the connector to which the message is to be transmitted. In present scenario, if capabilities C1 and C3 of the connectors 615 and 625 have matched record, then based on set rules the middleware 610 selects one of the capable connectors with matched record. If the middleware 610 transmits the message to the connector 615, the connector 615 transmits the message to corresponding target system 630 and provides access to the target system 630 to request processing or access to data 655.

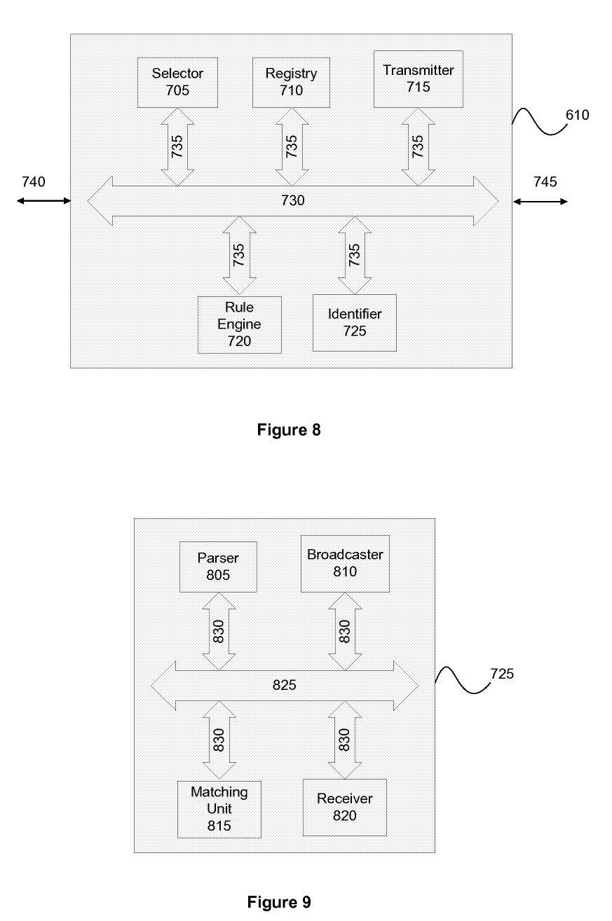

In FIG. 8, architecture of a middleware according to an embodiment of the invention is shown. The middleware 610 includes an identifier 725, a selector 705, a registry 710, a transmitter 715 and a rule engine 720. The identifier 725 dynamically identifies a connector (refer FIG. 5 and FIG. 6, 615, 620 and 625) for a plurality of target systems (refer FIG. 5 and FIG. 6, 630, 635 and 640) that is capable of handling the message. The identifier is described in greater detail below. The registry 710 retains a persistent record of capabilities (refer FIG. 7, C1, C2, C3) of connectors (refer FIG. 7, 615, 620, 625) with connector identifiers, when each connector connects to the middleware (refer FIG. 7, 610). The connector identifiers enable matching of set of capabilities, as defined in the header, required to handle the message with the persistent record. The selector 705 selects a connector from capable connectors to receive the message, when more than one connector is capable of handling the message. The selection of a connector by the selector 705 is based upon the rules set by and stored in the rule engine 720. The transmitted 715 transmits the message the selected capable connector. It may be observed that the identifier 725, the selector 705, the registry 710, the transmitter 715 and the rule engine 720 communicate among each other through communication channels 730 and 735 respectively. In addition, the middleware (refer FIG. 6 and FIG. 7, 610) communicates with the client system (refer FIG. 6, 605 and FIG. 7, 605) on side 740 and with the connectors (refer FIG. 6, 615, 620, 625 and FIG. 7, 615, 620, 625) on side 745.

FIG. 9 illustrates architecture of an identifier 725 according to an embodiment of the invention. The identifier 725 includes a broadcaster 810, a parser 805, a matching unit 815 and a receiver 820.

In one embodiment, the broadcaster 810 broadcasts a header (refer FIG. 6, 650) of the message to a plurality of connectors (refer FIG. 6, 615, 620, 625). The receiver 820 receives a message from the client system (refer FIGS. 6 and 7, 605). The receiver 820 also receives a response (refer FIG. 6, R1 and R2) from connectors (refer FIG. 6, 615 and 625) which are capable of handling the message. The receiver also receives capabilities (refer FIG. 7, C1, C2 and C3) from each connector (refer FIG. 7, 615, 620 and 615), when the connector connects to the middleware.

In another embodiment, the identifier includes a parser 605, which parses a header of the message for a set of capabilities required to handle the message. The matching unit 815 matches the set against the persistent record stored in the registry to identify the connectors with matched records. The connectors with the matched records are capable of handling the message.

As described above, the selector selects a connector from capable connectors to receive the message. The payload (refer FIG. 6, 645) or the message (in FIG. 7) is then transmitted to the selected capable connector by the transmitter (refer FIG. 8, 715).

It may be observed that the broadcaster 810, the parser 805, the matching unit 815 and the receiver 820 communicate among each other through communication channels 825 and 830 respectively. In addition, the middleware is provided as a library which provides to the client system a well defined set of application programming interfaces (APIs) to access the middleware and the target systems through connectors associated with such target systems. Those skilled in the art will recognize that many other embodiments with respect to structures of the middleware and the identifier are possible and fully within the scope and spirit of this disclosure, such as including the receiver in the middleware to receive the message and the registry in the identifier.

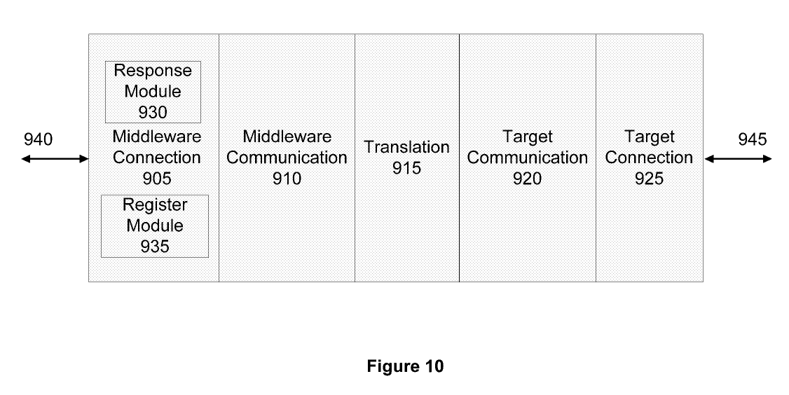

FIG. 10 illustrates architecture of a connector according to an embodiment of the invention. The connector implements various programming models, and interfaces provided by the middleware to establish connections, communication, and translation functions to communicate and access the target systems. The connector connects the middleware and manages the communication of the middleware (refer FIGS. 6 and 7, 610) with the target system.

The connector includes a middleware connection layer 905 to set a middleware connection with the connector, a middleware communication layer 910 to manage the middleware connection, a translation layer 915 to translate the message from a middleware understandable structure to a target system understandable structure and vice versa. The content of the data remains constant through the translation. A target connection layer 925 to set a target system connection and a target communication layer 920 to manage the target system connection. The connection layers 905 and 925 perform specific startup and shutdown routines. The communication layers 910 and 920 perform communication management and may include error logging, transaction coordination and application data polling.

In one of the embodiments, the connector includes a response module 930 to notify the middleware if the connector is capable of handling the message corresponding to a header received at the connector. Similarly, the connector includes a register module 935 to provide capabilities of the connector to the middleware responsive to a condition. The condition may include connection of the connector to the middleware. The condition may also include an explicit request send by the middleware requesting the connector to reregister, or registration responsive to a soft or hard reset to the extent that such reset would not otherwise be deemed to result in an initial connection.

It may be observed that the response module 930 and the register module 935 are shown in the middleware connection layer 905. Those skilled in the art may modify the connector by including the response module 930 and the register module 935 in other layers as well, such as in the middleware communication layer 910. Such modifications will be in scope of this disclosure.

Other embodiments of the invention may be implemented in digital electronic circuitry, or in computer hardware, firmware, software, or in combinations of them.

Elements of the invention may also be provided as a machine-readable medium for storing the machine-executable instructions. The machine-readable medium may include, but is not limited to, Flash memory, optical disks, CD-ROMs, DVD ROMs, RAMs, EPROMs, EEPROMs, magnetic or optical cards, propagation media or other type of machine-readable media suitable for storing electronic instructions.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims which follow.

What is claimed is:

1. A method comprising:
receiving a message at a middleware;
dynamically identifying if a connector for a target system is capable of handling the message; and
transmitting the message to a capable connector.

2. The method of claim 1, wherein dynamically identifying comprises:
broadcasting a header of the message to the connector; and
receiving a response at the middleware from the capable connector.

3. The method of claim 2, further comprising selecting from responding connectors a connector to receive the message, when a plurality of connectors is connected to the middleware.

4. The method of claim 1, further comprising:
receiving capabilities at the middleware from a connector when the connector connects to the middleware; and
retaining a persistent record of the capabilities in the middleware.

5. The method of claim 4, wherein dynamically identifying comprises:
parsing a header of the message for a set of capabilities required to handle the message; and
matching the set against the persistent record.

6. The method of claim 5, further comprising selecting from the connectors with matched record a connector to receive the message, when a plurality of connectors is connected to the middleware.

7. The method of claim 2, wherein the header includes at least one of object types, user identifiers, object instances, scenario, message identifiers, version or extensible custom properties.

8. The method of claim 4, wherein the capabilities includes at least one of a system connectivity capability, an object types supported, users supported, operations supported or extensible properties.

9. The method of claim 1, further comprising setting rules in the middleware to select the capable connector.

10. An article of manufacture, comprising:
a machine readable medium that provides instructions, which when executed by a machine, causes the machine to:
receive a message at a middleware;
dynamically identify if a connector for a target system is capable of handling the message; and
transmit the message to a capable connector.

11. The medium of claim 10, wherein the machine readable medium provides instructions, which when executed by a machine, causes the machine to:
broadcast a header of the message to the connector; and
receive a response at the middleware from the capable connector.

12. The medium of claim 11, wherein the machine readable medium provides instructions, which when executed by a machine, causes the machine to select from the responding connectors a connector to receive the message, when a plurality of connectors is connected to the middleware.

13. The medium of claim 10, wherein the machine readable medium provides instructions, which when executed by a machine, causes the machine to:
receive capabilities at the middleware from a connector when the connector connects to the middleware; and
retain a persistent record of the capabilities in the middleware.

14. The medium of claim 13, wherein the machine readable medium provides instructions, which when executed by a machine, causes the machine to:
parse a header of the message for a set of capabilities required to handle the message; and
match the set against the persistent record.

15. The medium of claim 10, wherein the machine readable medium provides instructions, which when executed by a machine, causes the machine to select from the connectors with matched record a connector to receive the message, when a plurality of connectors is connected to the middleware.

16. The medium of claim 10, wherein the machine readable medium provides instructions, which when executed by a machine, causes the machine to set rules in the middleware to select the capable connector.

17. A system comprising:
a client system to provide a message to a middleware;
an identifier in the middleware to dynamically identify if a connector for a target system is capable of handling the message; and
a transmitter to transmit the message to a capable connector.

18. The system of claim 17, further comprising:
a broadcaster to broadcast a header of the message to the connector; and
a receiver to receive a response at the middleware from the capable connector.

19. The system of claim 18, wherein the connector comprises a response module to notify the middleware if the connector is capable of handling the message corresponding to a header received at the connector.

20. The system of claim 18, further comprising a selector to select from the responding connectors a connector to receive the message, when a plurality of connectors is connected to the middleware.

21. The system of claim 17, wherein the connector comprises:
a register module to provide capabilities of the connector to the middleware responsive to a condition.

22. The system of claim 17, wherein the middleware comprises:
a registry to retain a persistent record of the capabilities of the connector;
a parser to parse a header of the message for a set of capabilities required to handle the message; and
a matching unit to match the set against the persistent record.

23. The system of claim 15, further comprising a rule engine in the middleware to set rules to select the capable connector.
